(19) United States
(12) Patent Application Publication
(10) Pub. No.: US 2009/0028650 A1
(43) Pub. Date: Jan. 29, 2009

(54) COMPOSITION AND METHOD FOR INCREASING RESISTANCE TO EROSION

(76) Inventor: Dennis Delamore, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 12/179,889

(22) Filed: Jul. 25, 2008

Related U.S. Application Data
(60) Provisional application No. 60/952,136, filed on Jul. 26, 2007.

(51) Int. Cl. E02D 3/00; C08F 2/00

(52) U.S. Cl. 405/302.6; 526/72

(57) ABSTRACT

Compositions, admixtures and methods for resisting erosion such as by wind and/or water are provided. The compositions comprise an emulsion, dispersion or suspension of a hydrophilic polymer. In preferred embodiments, the polymer comprises branched anionic polyacrylamide. The composition may be combined with water and optionally a matrix material, to form an admixture that is applied to the soil or other material needing erosion resistance. The matrix material preferably comprises cellulose and/or mulch. The methods comprise providing or forming an aqueous mixture of the compositions and applying them to an area of land or material sought to be provided with erosion resistance.

### CROSS-REFERENCE TO RELATED APPLICATIONS

The present application claims priority to Provisional Patent Application Ser. No. 60/952,136, entitled COMPOSITION AND METHOD FOR INCREASING RESISTANCE TO EROSION, filed on Jul. 26, 2007.

### STATEMENT RE: FEDERALLY SPONSORED RESEARCH/DEVELOPMENT

Not Applicable

### BACKGROUND

The invention relates to compositions, admixtures, and methods which impart improved erosion resistance to materials to which they are applied, such as soil.

Soil erosion, namely, the detachment of particles of soil and surface sediments and rocks, is a serious problem recognized worldwide. Essentially, erosion occurs via the forces of wind and water that facilitate the movement of small particulate material such as topsoil from one place to another. Of such forces, water erosion is generally considered more detrimental to soils both by the volume of soil removed, and the area of land influenced. Moreover, although soil erosion can potentially occur in any land surface, sloping areas mantled with soil or loose sediment are particularly susceptible to such forces.

In the realm of agriculture, control of erosion has a direct impact on the cost of producing a crop as well as on the long-term sustainability of arable land. Fisheries are directly impacted when silt resulting from soil erosion increases the turbidity of river waters and when deposition of eroded soils in riverbeds alters fish habitat. Quality of human life suffers when hillsides are destroyed, creeks and streams are muddied and water supplies are excessively loaded with silt.

Due to its significance, several attempts have been made to prevent or substantially reduce soil erosion. Vegetation has been planted on bare hillsides so that the root structure and water-absorption capacity of the plants will stabilize the soil; one example of this approach is the use of crown vetch (Coronilla varia) in the reclamation of strip-mines in Pennsylvania. Agricultural practices, such as contour farming and terracing, no-till cultivation, strip farming and polyvarietal cultivation have also been used. Contour plowing is an established farming technique that aims to retard erosion by plowing furrows perpendicular to the slope of the field to retard runoff and enhance rainwater or irrigation absorption. Other well-known approaches include adding organic matter to soil which, by biochemical degradation, produces polysaccharides that are cohesive in nature and act to cause soil particles to stick together and resist erosion. Along these lines, products have been introduced to provide at least temporary erosion control, particularly with respect to slopes and the like until such time as trees and vegetation can take root to resist erosion. Such products include bonded fiber matrices, which comprise a continuous layer of elongated fiber strands held together by a water-resistant bonding agent. Such product helps to eliminate direct raindrop impact on soil and further includes high water-holding capacity that eventually biodegrades into plant nutrients. Other types of sheets, fabrics, woven materials, cast materials, and membranes have been used to protect hillsides and slope areas temporarily or long-term. Emulsions of heavy organic chemicals have been used in which evaporation of the carrier water leaves a sticky residue that binds small soil particles together, or creates a tarry impervious surface layer, to slow rain or wind erosion, such as the use of organic binders on the surface of coal piles or coal in open rail cars to prevent rain from washing fine coal from the piles or to prevent wind from blowing fines from the rail cars during transport. Compositions including mulch and linear polyacrylamides have also been used.

### BRIEF SUMMARY

In accordance with a preferred embodiment there are provided compositions, admixtures, and the methods for reducing soil erosion. In a preferred embodiment, a composition comprises a branched hydrophilic polymer. In other preferred embodiments, the composition further comprises a solid matrix material comprising an organic or biodegradable material, including, but not limited to, cellulose, mulch, sawdust, bark pieces, paper, recycled paper, straw, and the like. The matrix material may also comprise seeds to promote germination and growth of grasses or other plants that can help stabilize soils and reduce or retard erosion. In preferred embodiments, the hydrophilic polymer is a branched anionic polyacrylamide. Although there may be some limited degree of crosslinking present in small, isolated domains in a branched polymer material, it is not present in such a degree so as to cause the polymer to be fully insoluble in water and swell when placed in water, like crosslinked polyacrylamides. Although compositions including linear anionic polyacrylamides are known, the high water solubility of the linear polymers allows such materials to be much more easily washed away by water as compared to the compositions described herein.

In accordance with a preferred embodiment, the composition for resisting soil erosion is made, sold, or otherwise provided in a form that can be later mixed with water with or without matrix material to form a hydrated composition which is then applied to the soil. The composition may take the form of a liquid or emulsion. In some embodiments, the composition is made, provided or sold having been pre-mixed with matrix material. Depending upon how much matrix material (if any) is mixed with the composition (prior to mixing with water) the product may take the form of a viscous liquid, powder, or solid, including a damp or sticky solid. The composition may then be mixed with water and optionally matrix material to form an admixture.

Preferred methods comprise providing an erosion-resistant composition of the aforementioned variety or admixture containing the same and applying it to an area of land or material sought to be treated to consequently resist erosion. According to a preferred embodiment, the method comprises forming an admixture of composition, water, and optionally matrix material. This may be done by combining a polymer composition with water to form an admixture; by forming a first admixture of water and composition, and thereafter adding the matrix material to form a second or final admixture; by forming a first admixture of polymer composition and matrix material, and thereafter adding the water to form a second or final admixture; or by forming a first admixture of water and matrix material and thereafter adding polymer to form a final admixture. However formed, the resultant admixture may be applied by any suitable means as will be understood by those skilled in the art, including, but not limited to, hydraulically by use of a hydroseeding machine or similar mix/pump/spray equipment.

In preferred embodiments, the compositions and methods for resisting erosion possess one or more of the following characteristics: they can resist erosion to a greater degree than prior art compositions and methods, including in relation to slopes and the like; they are non-toxic, biodegradable and safe for the environment; they are of similar or lower cost per acre than alternative technologies; they can be readily applied utilizing currently known application equipment and techniques; they are effective immediately upon application; they can be applied in any type of weather; and/or they can be utilized on virtually any type of soil or other material.

In preferred embodiments, the composition and/or admixtures described herein provide a high level of performance with decreased environmental impact. By virtue of the improved effectiveness, lower dosage rates are needed, thereby reducing potential impacts from the product's components. Further, preferred components are demonstrably safe based on their inherent chemistries and the extremely low levels of by-products associated with the active components.

This product offers superior protection against wind and water erosion of soils and minerals. The unique chemistry of the active components binds smaller particles (those more susceptible to erosive forces) more tightly than conventional chemistries and gives the product its performance advantage. The composition and admixtures may be used to suppress wind and/or water erosive effects in any situation, including, but not limited to on soils, such as in agricultural applications or slopes, mineral piles like coal or fly ash, haul road berms at mines, quarries, construction sites, etc., rail cars transporting coal, trucks transporting dirt, and the like.

### BRIEF DESCRIPTION OF THE DRAWINGS

These as well as other features of the present invention will become more apparent upon reference to the drawings wherein:

FIG. 1 is a graph showing runoff and turbidity from soil boxes for bare soil (control), 3,000 lb/acre wood fiber+TAG, and 4,700 lb/acre wood fiber+TAG;

FIG. 2 is a photo image of runoff water from 3,000 lb/acre wood fiber+TAG, control (bare soil), and 4,700 lb/acre wood fiber+TAG; and

FIG. 3 is a photo image of test boxes after rainfall simulations showing 4,700 lb/acre wood fiber+TAG and a control.

Common reference numerals are used throughout the drawings and detailed description to indicate like elements.

### DETAILED DESCRIPTION

The compositions and methods presented herein are for substantially preventing or reducing erosion of soil and similar materials such as by wind and/or water. The compositions may be mixed with water and/or a matrix material to form an admixture suitable for application. The composition preferably comprises branched anionic polyacrylamide. The matrix material preferably comprises cellulose, mulch and/or seed and mulch, including materials such as recycled paper mulch and/or wood fiber mulch, among several other matrix materials.

It is understood that the percentages by weight of the components in a composition will total 100% by weight for the composition, and if other materials are included in the composition, the percentages of all ingredients will total 100% by weight. All percentages set forth in the present specification and claims are by weight unless expressly stated otherwise.

In preferred embodiments, the hydrophilic polymer comprises branched anionic polyacrylamide polymer. In a preferred embodiment, the polymer comprises a copolymer of acrylamide and sodium acrylate with methylene bisacrylamide as the branching agent. The polymer may be made by reacting the monomer blend under polymerization conditions, such as those known in the art, except that branching agent is included in the monomer charge. The amount of branching agent and the polymerization conditions under which the monomer charge is reacted to form the polymer are selected in such a manner that the polymer is a branched polymer and is not a linear polymer or a water insoluble swellable cross linked polymer. Some preferred branched anionic polyacrylamides are those described in U.S. Pat. No. 6,310,157, which is hereby incorporated by reference in its entirety.

Presently preferred branched anionic polyacrylamides are commercially available in the form of an emulsion, dispersion or suspension from several sources, including that sold as Polyflex®, including Polyflex X100, from Ciba Specialty Chemicals Corporation (Suffolk, Va.), and that sold as Floret MPA 2211 from SNF Inc. (Riceboro, Ga.). In a preferred embodiment, the emulsion, dispersion or suspension comprises 35-45% mineral oil, 1-5% stabilizer, and 1-3% mineral spirits. In a preferred embodiment, the emulsion, dispersion or suspension includes about 30-60% polymer by weight, including about 45-55% by weight, and 50-60% by weight.

The composition preferably includes about 75%-98% by weight of branched anionic polyacrylamide emulsion/dispersion/suspension, including about 80%-95% by weight, and 85%-95% by weight of the suspension.

In certain preferred embodiments, the composition comprises dry ionic polyacrylamide, preferably anionic polyacrylamide. The polymer may be linear and/or branched. One preferred dry anionic polyacrylamide is available commercially as Flopam AN 905SH from SNF Inc. (Riceboro, Ga.). A cationic polyacrylamide is Flopam FO 4698 from SNF Inc. (Riceboro, Ga.). To state the obvious, when included in the composition and admixtures, the dry material ceases to be dry. The term “dry” refers to the form in which it is added to the mixture to form the composition.

The composition preferably comprises about 5-15% dry polymer by weight, including about 7-12% and 10-15% by weight.

The composition may include one or more other additives. Preferred additives include stabilizers, surfactants, and emulsifiers. In a preferred embodiment, the additives total 0.1%-10% by weight, including 0.2%-6%, and 1%-5%. Each individual additive may be present at 0.1%-10%, including 0.1%-5%, 0.2%-3% and 1%-2%. Examples of specific preferred additives include tall oil, and Polyalkylene glycol ethers (including PEG mono(nonyl phenyl) ether).

For application, the polymer composition will be mixed with water and optionally a matrix material. In preferred embodiments, the admixture of water and composition includes the following relative amounts: 0.5-3 gallons of composition (including 1-2 gallons composition) per 1,000 gallons of water, or about 10-15 pounds of composition (including 12-14 pounds of composition) per 1,000 gallons of water. In preferred embodiments where a matrix material is used, the matrix material may be included preferably at about 100-1,200 pounds per 1,000 gallons of water, including about 100-500 pounds per 1,000 gallons. The amount of matrix material that is added may depend upon a variety of factors, including but not limited to the degree of protection desired, the amount of composition added, the type of matrix material used, and the method of application. The preceding figures provide relative proportions, and should not be read to require the use of water in 1,000 gallon increments only; the proportions can be used to determine a suitable formulation of any scale using simple mathematics.

With respect to application, the composition and admixtures may be applied by any of a variety of techniques, including those known in the art. For example, the compositions and admixtures may be applied via hydroseeders, among others well-known in the art. As will be appreciated by those skilled in the art, the resultant admixture may be a gel or slurry that will benefit from constant agitation, such as through the use of agitators and the like, or by thorough mixing at the time such ingredients are in contact with one another.

Advantageously, the compositions are non-toxic, biodegradable and can be applied to any types of soils in any type of weather conditions. Moreover, in studies involving the aforementioned compositions, the same were shown to reduce erosion and sediment runoff by approximately 95% when compared to untreated soil conditions. As is known in the art, such reduction in sediment runoff is comparable, if not better, to the best performing best management practices known in the art.

### EXAMPLES

### Example 1

An erosion control composition was made with the following components: 88% by weight branched anionic polyacrylamide emulsion (Floret MPA 2211), 10% by weight dry polyacrylamide) Flopam AN-905 SH), 1% by weight tall oil (L5 from Mead Westvaco, Charleston, S.C.), and 1% by weight polyethylene glycol mono(nonyl phenyl)ether (Makon 10 from Stepan, Northfield, Ill.). The ingredients were combined and mixed to make the composition.

### Example 2

An erosion control composition was made with the following components: 94% by weight branched anionic polyacrylamide emulsion (Polyflex X100), 4.5% by weight tall oil (L5), and 1.5% by weight polyethylene glycol mono(nonyl phenyl) ether (Makon 10). The ingredients were combined and mixed to make the composition.

Testing

Testing of the composition was conducted at North Carolina State University, Sediment and Erosion Control Research and Education Facility, Raleigh, N.C. Tests were conducted in a stationary rainfall simulator using soil boxes (2×1 m) tilted to a 2:1 slope. These were packed with a sandy clay loam soil and the treatments were applied prior to placing them under the spray nozzles. The treatments consisted of either 3,000 or 4,700 lb/ac of a wood fiber mulch mixed with 1.65 gallons of the TAG product (formulations as per Example 1 above) per 1,000 gallons of water in the hydroseeder tank (Turfmaker 420). The lower rate is the recommended rate for the mulch but it did not provide complete coverage, so the higher rate was a visual coverage to 100% and a calculation of the amount applied. The resulting polyacrylamide application rates are 44 and 68 lb/ac for the 1,000 and 4,700 lb/ac wood fiber rates. A second round of testing was done at 0.82 gallons of the TAG product per 1,000 gallons and the 4,700 lb/ac wood fiber rate, for a 34 lb/ac PAM application. The control received no treatments.

The rainfall pattern was 5 mm/hour for 30 minutes, 40 mm/hour for 40 minutes, and 5 mm/hour for another 30 minutes. All runoff was collected and the volume measured, then a subsample was taken for analysis. Turbidity and total suspended solids was determined on the samples using a turbidity meter (Hach TC-3000e) and by filtration, respectively.

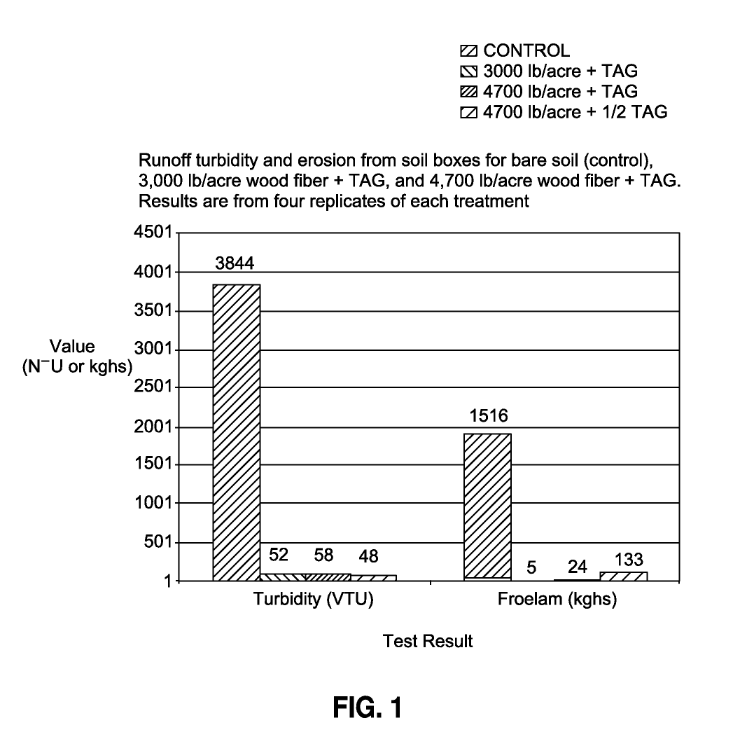

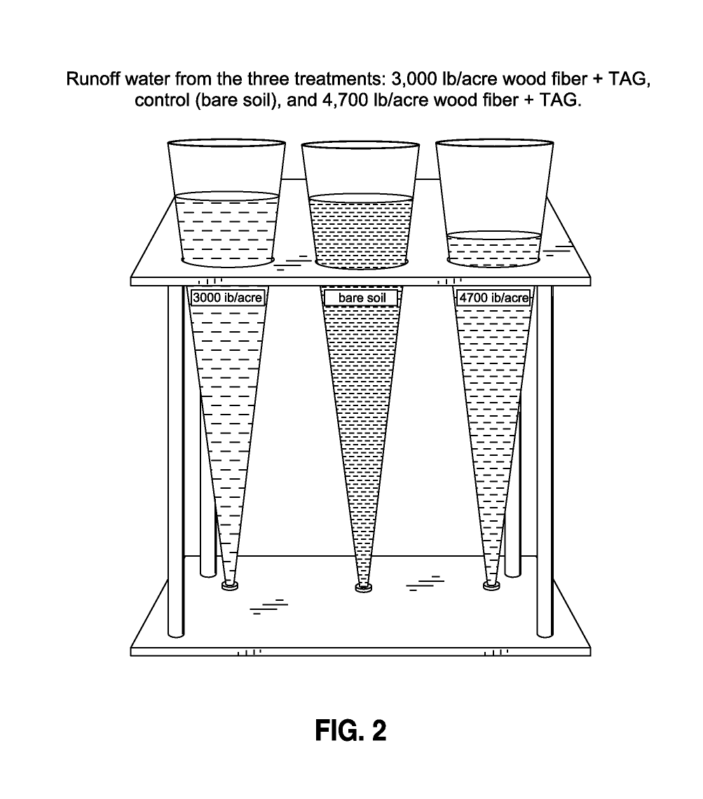

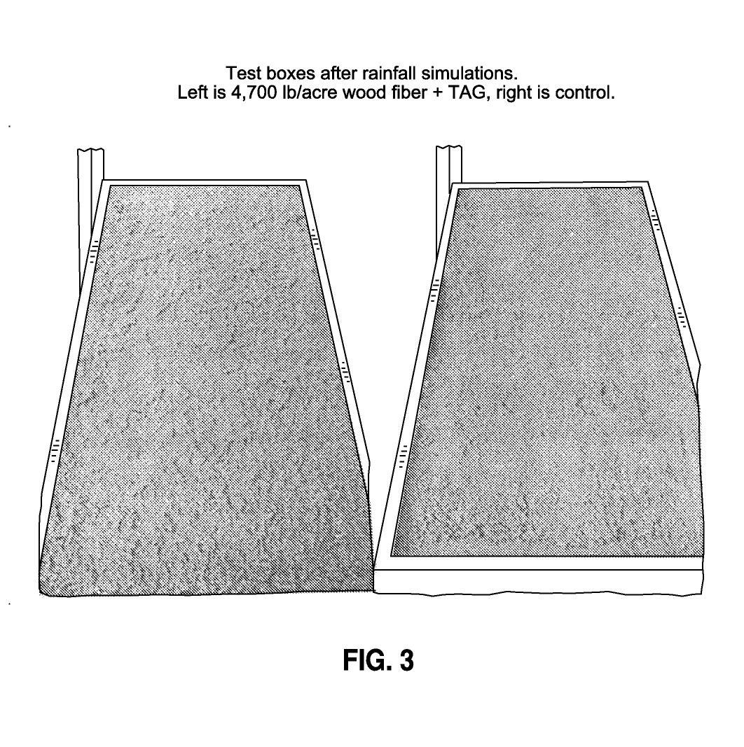

The time to runoff and volume of runoff were not significantly different between the treatments. Both of the wood fiber rates reduced turbidity and erosion by 97-99% compared to the control (FIG. 1). In fact, there was little evidence of soil in the runoff in the TAG treatments but some fiber and color from the hydromulch contributed to these readings (FIG. 2). The boxes are shown in FIG. 3 after the rainfall simulation.

The description as set forth herein is intended as a description of certain presently preferred embodiments of the invention, and is not intended to represent the only forms in which the composition may be made or utilized. Additional modifications and improvements of the disclosed embodiments may also be apparent to those of ordinary skill in the art. Thus, the particular combination of ingredients and steps described and illustrated herein is intended to represent only certain embodiments, and is not intended to serve as limitations of alternative compositions and methods within the spirit and scope of the invention. The description sets forth the functions and sequences of steps for making and using the composition in connection with the described embodiments. It is understood, however, that the same or equivalent functions, compounds, and steps may be accomplished by different embodiments and that they are also intended to be encompassed within the scope of this invention.

What is claimed is:

1. An erosion control composition comprising:
an emulsion, dispersion or suspension of branched anionic polyacrylamide;
optionally including dry polyacrylamide, and one or more additives selected from stabilizers, surfactants, and emulsifiers.

2. An erosion control formulation for application to soil or other material to enhance erosion resistance, comprising:
an admixture of the composition according to claim 1 and water, and optionally including a matrix material.

3. The formulation of claim 2 wherein the matrix is selected from the group consisting of cellulose, mulch, and seed combined with mulch.

4. The formulation of claim 3 wherein the mulch is selected from the group consisting of paper mulch and wood fiber mulch.

5. The composition or formulation of claim 1 wherein the polymer emulsion, dispersion or suspension comprises 35-45% mineral oil, 1-5% stabilizer, and 1-3% mineral spirits.

6. The composition or formulation claim 1 wherein the polymer emulsion, dispersion or suspension comprises about 30-60% polymer by weight.

7. The composition or formulation of claim 1 wherein the composition comprises about 75%-98% by weight of branched anionic polyacrylamide emulsion/dispersion/suspension.

8. The composition or formulation of claim 1 wherein the composition comprises about 5-15% dry anionic polyacrylamide by weight.

9. The composition or formulation of claim 1 wherein the composition comprises 0.1-5% tall oil.

10. The composition or formulation of claim 1 wherein the composition comprises 0.1%-5% polyethylene glycol mono(nonyl phenyl)ether.

11. The composition or formulation of claim 1 wherein the admixture comprises 0.5-3 gallons of composition per 1,000 gallons of water.

12. The composition or formulation of claim 1 wherein the admixture comprises about 10-15 pounds of composition per 1,000 gallons of water.

13. The composition or formulation of claim 1 wherein the admixture comprises 100-1,200 pounds of matrix material per 1,000 gallons of water.

14. A method for reducing erosion on an area of land or material comprising applying the admixture according to claim 2 to the land or material.

15. The method of claim 14 wherein the material includes soil, dirt, dust, stone dust, minerals, coal, and ash.

16. The method of claim 14 wherein the land or material is a slope, valley, plain, grade, landfill, pile, berm, truck or traincar.
